(19) United States
(12) Patent Application Publication
(10) Pub. No.: US 2009/0228324 A1
(43) Pub. Date: Sep. 10, 2009

(54) Method and System for Efficient Energy Distribution in Electrical Grids Using Sensor and Actuator Networks

(76) Inventors: Ronald Ambrosio, Poughquag, NY (US); Nagui Halim, Yorktown Heights, NY (US); Zhen Liu, Tarrytown, NY (US); Dimitrios Pendarakis, Westport, CT (US); Mark G. Yao, Hicksville, NY (US)

Correspondence Address: RYAN, MASON & LEWIS, LLP, 90 FOREST AVENUE, LOCUST VALLEY, NY, 11560, US

(21) Appl. No.: 12/042,012

(22) Filed: Mar. 4, 2008

(51) Int. Cl. G06Q 10/00; G05D 7/06; G06F 17/10; G06Q 30/00

(52) U.S. Cl. 705/10; 700/291; 701/90

(57) ABSTRACT

Techniques are disclosed for managing a commodity resource in a distributed network by aggregating marginal demand functions or marginal supply functions, depending on whether a node is a commodity consumer or a commodity producer, and determining an optimal allocation/production based on the aggregated function. By way of example, the commodity being managed may be an energy-based commodity such as electrical energy. In such case, the distributed commodity resource-based network may be a distributed electrical grid network.

### FIELD OF THE INVENTION

The present invention relates to energy distribution in electrical grids and, more particularly, to energy distribution in electrical grids using sensor and actuator networks.

### BACKGROUND OF THE INVENTION

Energy conservation and efficiency has become an area of vital economic, environmental and social importance. At the same time, utility industry deregulation and the increasing deployment of grid-connected alternative energy systems are making the production and distribution of energy significantly more decentralized than in the recent past. However, this trend toward decentralization makes the management of electrical grids a critical issue.

Prior work in managing loads in electrical grids includes schemes for forecasting of loads, based on day of the week, time of day, weather conditions, etc., that aim to determine more accurately the amount of electricity that needs to be produced to match the demand. These schemes rely on statistical analysis of historical, aggregate loads, but do not attempt to manage load, for example to handle failures or power surges. Prior work in managing loads in electrical grids includes schemes for monitoring of electrical signal under-frequency and/or under-voltage conditions (within a prescribed bound), which indicate stress conditions on the grid.

More recently, schemes that attempt to optimize electricity distribution in an open market environment, by managing demand, have been proposed and demonstrated. An example is the GridWise Olympic Peninsula Testbed demonstration in the Pacific Northwest. These schemes assume that electricity consumers (residential, commercial, industrial) are equipped with gateways that provide data communications capability with a central bidding and pricing server. These gateways are equipped with software applications that bid for electricity, on behalf of the consumers, in an open electricity marketplace. The bids are determined by the consumer's willingness to pay for particular amounts of usage at a particular time, also given conditions such as external temperature, etc. These demonstrations have involved a small number of residential and commercial customers connected to a central energy clearing house that sets the price of energy. The price is computed in regular intervals and disseminated to consumers, who in turn adjust their usage through an automated application. However, a centralized solution such as this central bidding scheme cannot scale to the magnitude of a complete grid.

### SUMMARY OF THE INVENTION

Principles of the invention provide techniques for managing a commodity resource in a distributed network by aggregating marginal demand functions or marginal supply functions, depending on whether a node is a commodity consumer or a commodity producer, and determining an optimal allocation/production based on the aggregated function.

In a first embodiment, in a distributed commodity resource-based network wherein a first node in the network distributes an amount of the commodity to two or more other nodes in the network, a method of managing distribution of the commodity includes the following steps. The first node obtains two or more marginal demand functions, respectively, from the two or more other nodes, wherein a marginal demand function represents a price for a given amount of the commodity that a given node is willing to pay. The first node aggregates the two or more marginal demand functions respectively obtained from the two or more other nodes to form an aggregated marginal demand function. The first node determines an optimal allocation of aggregate amounts of the commodity to the two or more other nodes based on the aggregated marginal demand function.

In a second embodiment, in a distributed commodity resource-based network wherein a first node in the network receives an amount of the commodity from two or more other nodes in the network, a method of managing production of the commodity includes the following steps. The first node obtains two or more marginal supply functions, respectively, from the two or more other nodes, wherein a marginal supply function represents a given amount of the commodity that a given node is willing to supply. The first node aggregates the two or more marginal supply functions respectively obtained from the two or more other nodes to form an aggregated marginal supply function. The first node determines an optimal production of aggregate amounts of the commodity from the two or more other nodes based on the aggregated marginal supply function.

In a third embodiment, a device that at least one of consumes and produces a commodity in a distributed commodity resource-based network includes the following components: a processor; a sensor coupled to the processor for monitoring at least one of consumption and production of the commodity; an actuator coupled to the processor for controlling at least one of consumption and production of the commodity; and an interface coupled to the processor for allowing the processor to communicate with the network. The processor generates one or more marginal utility functions that represent at least one of: (i) a price for a given amount of the commodity that the device is willing to pay when operating as a consumer of the commodity; and (ii) a given amount of the commodity that the device is willing to supply when operating as a producer of the commodity. Further, the processor sends the marginal utility function to a controller in the network for aggregating multiple marginal utility functions respectively obtained from multiple devices in the network and for determining at least one of an optimal allocation and production of the commodity.

By way of example, the commodity being managed may be an energy-based commodity such as electrical energy. In such case, the distributed commodity resource-based network may be a distributed electrical grid network.

These and other objects, features and advantages of the present invention will become apparent from the following detailed description of illustrative embodiments thereof, which is to be read in connection with the accompanying drawings.

### BRIEF DESCRIPTION OF DRAWINGS

FIG. 1 shows an intelligent energy distribution and generation network, according to an embodiment of the invention.

FIGS. 2(A) through 2(C) show utility functions for intelligent energy consuming devices, according to embodiments of the invention.

FIGS. 3(A) through 3(C) show utility functions shown as marginal demand functions, according to embodiments of the invention.

FIG. 4 shows aggregation of utility functions, according to an embodiment of the invention.

FIG. 5 shows allocation of total energy to individual child domains/devices, according to an embodiment of the invention.

FIG. 6 shows an intelligent energy consuming device, according to an embodiment of the invention.

FIG. 7 shows an intelligent energy generating device, according to an embodiment of the invention.

### DETAILED DESCRIPTION OF PREFERRED EMBODIMENTS

While illustrative embodiments of the invention will be described below in the context of electrical energy, it is to be understood that principles of the invention are not limited thereto but rather are more generally applicable to other forms of energy or commodities.

Intelligent electrical grids aim to transform an electrical grid into a collaborative network, using intelligent sensors and actuators, advances in communications and information management techniques, with the aim of: (i) increased energy efficiency via demand management and improved matching of demand and supply; (ii) improved reliability and resiliency via a fast and collaborative response to energy shortages, catastrophic events, such as power plant or distribution grid failures.

An intelligent grid includes energy consuming and producing devices, equipped with sensors, actuators and data communication capabilities, in residential, commercial and industrial environments. Such devices may include household appliances such as washers, dryers and water heaters, heating and air conditioning (AC) systems, machinery, etc. Sensors may include legacy, electromechanical, and electronic devices capable of sensing the power usage, voltage, temperature, etc. Actuators may include devices that are capable of regulating the consumption or generation level of an electrical device, by setting appropriate parameters such as temperature, voltage, current, etc. The network comprising the collection of all these devices across an entire grid may be very large, potentially numbering billions of devices for a grid spanning the United States, for example.

Embodiments of the invention provide methods for developing and operating a system that can control the generation and distribution of electricity across such a very large distributed system.

More particularly, embodiments of the invention provide a distributed hierarchical network that controls the distribution of electricity or other similar commodity such as water, natural gas or oil. There are thus logically two networks involved in embodiments of the invention, i.e., the physical commodity distribution network and the control network. The control network comprises sensors, actuators, gateways, controllers and other processing elements overlayed on top of a physical commodity distribution network such as a large electrical grid. The control hierarchy may use the public Internet as the communication infrastructure or use a private network within a utility or national grid. It may use physical data networking infrastructure comprising Internet Protocol (IP) over power lines, wireless links, IP over cable, etc.

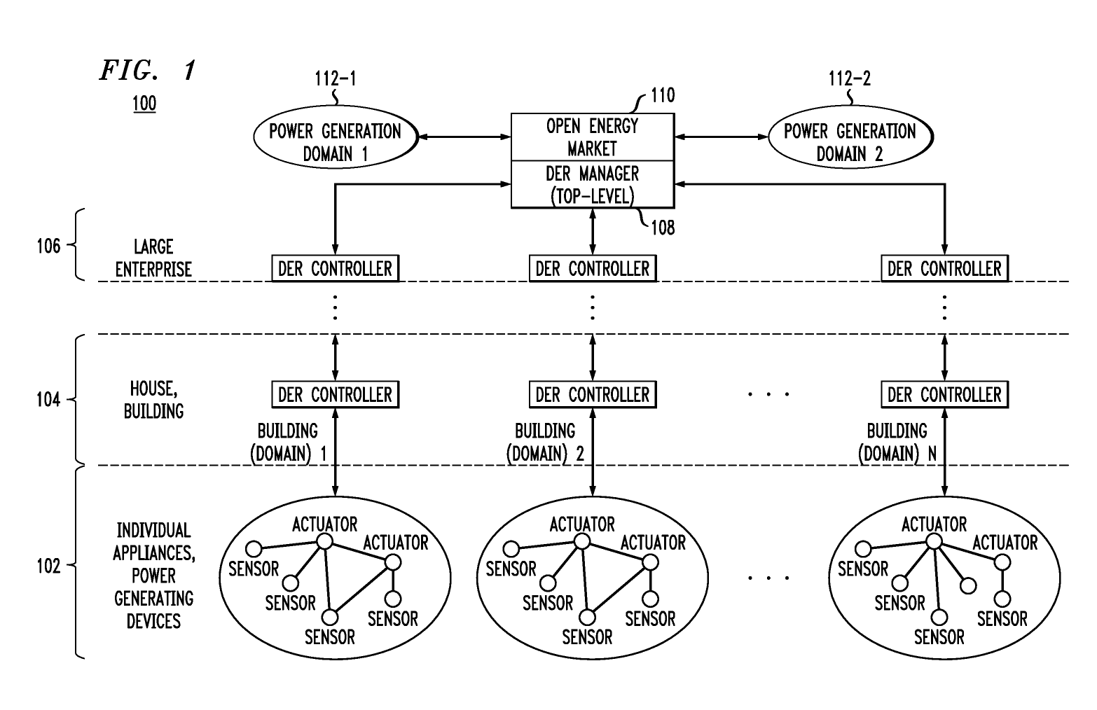

FIG. 1 shows network 100 comprising a control topology, together with underlying sensors and actuators in intelligent energy devices, as well as gateways and controllers, according to an embodiment of the invention. It is to be appreciated that each individual element in the network, or even a group of such elements, may be considered a “node” of the hierarchy, wherein nodes that are responsive to or dependent on (also, in this illustrative figure, ones that are below) other nodes in the hierarchy are considered “child nodes” or “children nodes,” while nodes upon which child nodes depend (also, in this illustrative figure, ones that are above) may be considered “parent nodes.” It is to be understood that a node can function as both a parent node (for nodes below it) and a child node (for nodes above it) within the hierarchy.

At the bottom of the hierarchy of FIG. 1 there are sensor and actuator devices (collectively referred to as 102) that are embedded within intelligent energy consuming devices such as appliances, heating and air conditioning systems, etc. These devices may be configured and controlled by devices such as gateways (collectively referred to as 104), identified as DER (distributed energy resource) controllers in FIG. 1, that are responsible for aggregating the information collected by individual devices and setting common objectives. Devices are organized in groups, or domains, based on ownership, administrative or geographic boundaries. For example, all the devices within a floor or house may belong to the same domain. Membership in the same domain implies a trust relationship between all the devices in that domain.

Devices and domains are recursively aggregated into larger domains as shown in FIG. 1. For example, all the houses within a neighborhood are aggregated within a larger neighborhood domain. In turn, all the neighborhoods can be aggregated into a larger city or enterprise domain, which may have one or more DER controllers (collectively referred to as 106). Alternatively, aggregation could occur based on customer contract types or other non-proximal criteria.

At the top of this hierarchy, there is a DER manager 108 and an energy utility or distribution grid which also interfaces with different power generation domains (e.g., 112-1, 112-2, . . . ) over an open market 110.

Embodiments of the invention are directed to a system that achieves optimal distribution of energy (or other applicable commodities) across different devices/consumers based on the utility (or willingness to pay) obtained by these devices/consumers for given amounts of energy. Embodiments of the invention propose two main components to achieve this objective:

(i) A method for efficiently aggregating, in a recursive manner, measurements and utility functions reported by child nodes and forwarding them “up” in the hierarchy; and

(ii) A method for allocating aggregate amounts of energy among children nodes based on the obtained aggregated utility functions.

Embodiments of the invention provide methods for trading accuracy of the aggregated utility functions and the computed usage targets with bandwidth and processing capacity.

Embodiments of the invention construct an intelligent control network on top of a physical distribution network such as the electrical grid, from sensors and actuators, embedded within electricity consumers and producers, and a hierarchy of controllers, as shown in FIG. 1, for example. The actuators are able to regulate the energy usage of the intelligent electricity consuming devices (appliance, heating, AC unit) given input from a controller. In times of high energy usage, when demand exceeds supply, some devices/consumers may be able to operate on a lower level of consumption, while when usage is low, the same device may operate at a higher consumption level.

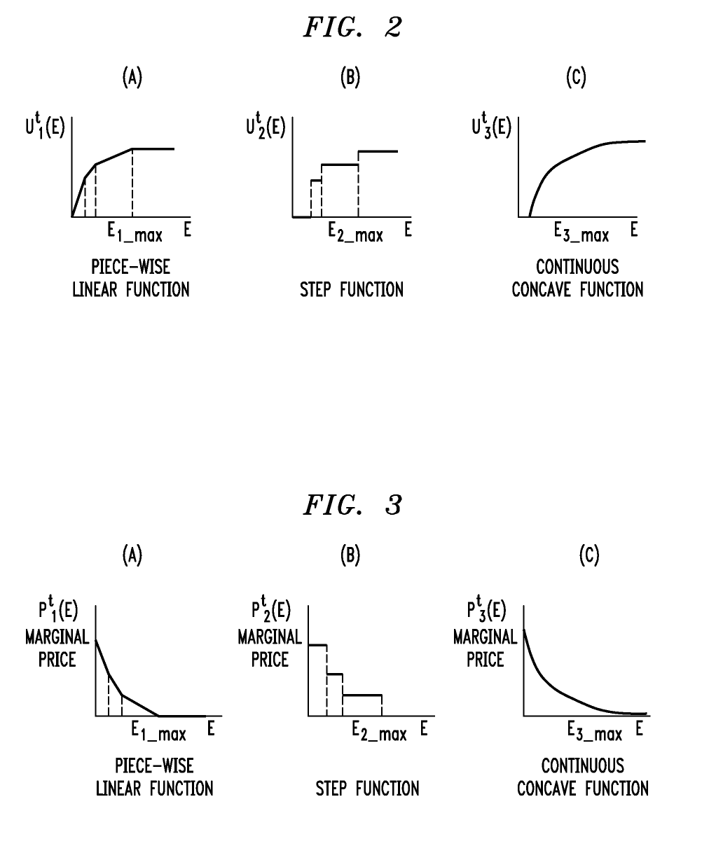

Examples of such intelligent devices include, but are not limited to, smart dryers that can adjust the level of heating power, electric heaters, air conditioning systems, fans, computers where the central processing unit (CPU) can adjust the frequency and even lights. In all these cases, the device is characterized by a function that expresses the benefit obtained by the device for a given level of electricity received. This function is time-dependent and may be either built-in by the manufacturer of the device or programmable by the user or both. We use the term utility function and show some examples for such functions in FIG. 2(A) (piece-wise linear), FIG. 2(B) (step), and FIG. 2(C) (continuous concave).

A few points can be observed regarding the utility functions:

(i) It is expected that utility functions will exhibit some sort of concavity, which is due to a “law of diminishing returns” behavior. In other words, the first unit(s) of energy used by a device yield the biggest increase in utility, successive additional units of energy yield increased utility, but by successively smaller amounts. Embodiments of the invention do not depend on the utility functions being concave.

(ii) The amount of utility obtained can also be interpreted as a “willingness to pay” or the marginal price. To view this graphically, one can plot the difference in utility values U(E+dE)−U(E) versus the amount of energy E. As in the above point (i), it is expected that the marginal price will decrease as the amount of energy consumed by a device increases. An end user will be willing to pay a high price for electricity to receive the minimum amount to keep a device operating (or the heater at the lowest temperature), but increasingly lower price for higher levels. Example marginal expressions of the same utility function examples shown in FIG. 2(A) through 2(C) are respectively shown in FIGS. 3(A) through 3(C).

The aggregate number of intelligent devices over a wide-area grid will be in the multiple millions or even billions. Given that each device will have a corresponding utility function, there is a need to aggregate utility functions and use them in determining, in a recursive manner, the optimal amount of energy to be used within a device, domain, neighborhood, etc.

Embodiments of the invention utilize an aggregation operation to aggregate utility functions and an optimized allocation operation to optimally distribute energy as main building blocks for achieving one or more of the advantages described herein. It is to be understood that such aggregation and allocation operations can be performed in one or more of the DER controllers of the distributed network.

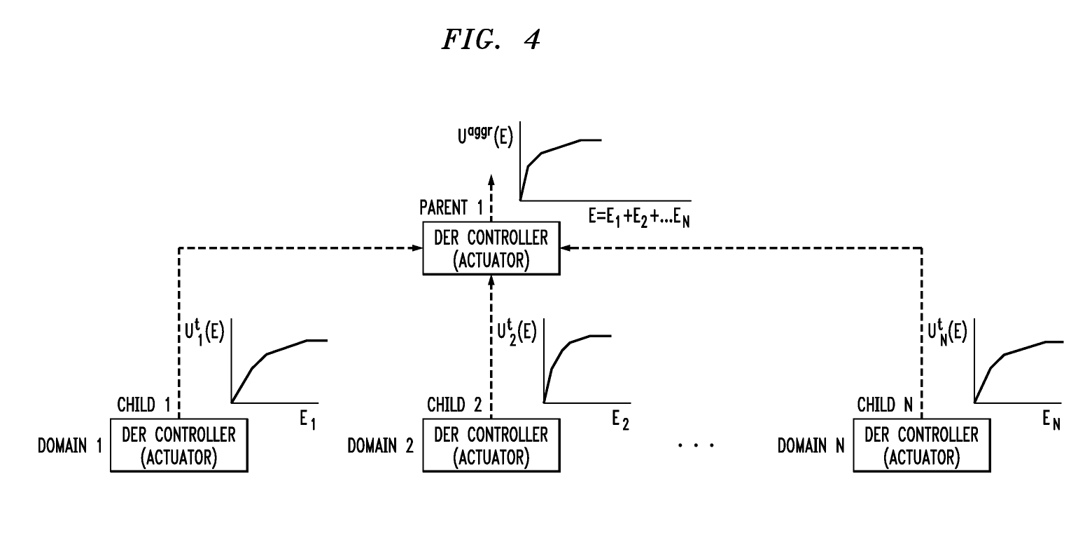

FIG. 4 shows an aggregation operation, which may be performed recursively in accordance with an embodiment of the invention. The objective of the aggregation is to determine, for each total amount of energy available at the parent level, what is the maximum aggregate utility that can be achieved by distributing the total energy among the different children. The aggregate utility can be computed in different ways, reflecting local policy. For example, the aggregate utility may be computed as:

(i) Sum of individual utility values: for each value of total energy, find the allocation of energy to individual devices that maximizes the sum of the individual utilities.

(ii) Weighted sum of utility values: as in the above approach, but with weighted sum instead of just sum.

(iii) Use max (min), which tries to capture fairness constraints.

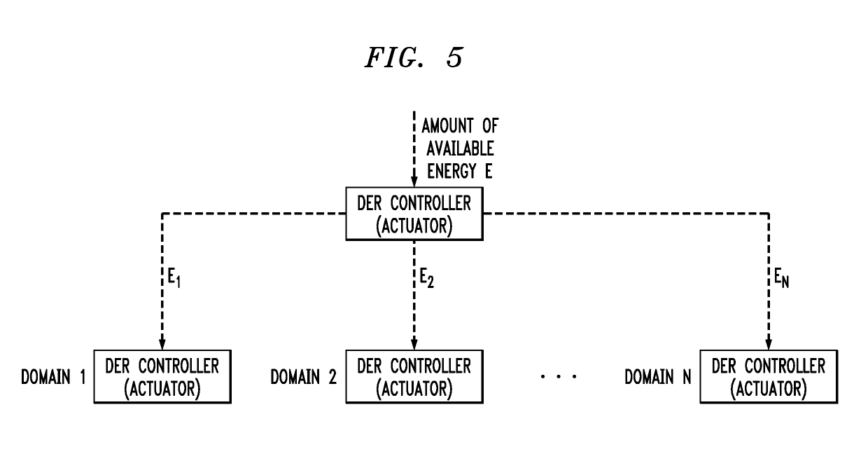

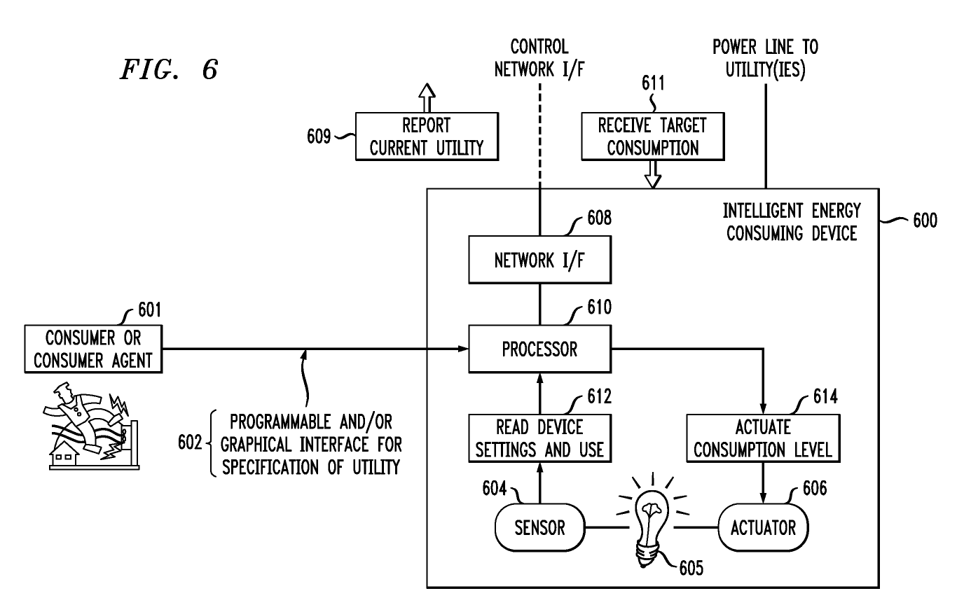

A second main building block of the invention is an optimized allocation module that allocates the amount of energy to individual children, as shown in FIG. 5.

If the individual controllers have convex utility functions, this problem can be solved as a convex optimization problem, that is, given the total amount of energy, find the allocation of that total amount of energy among different sub-controllers so as to maximize the sum of the utilities over all controllers. A set of different utility aggregation functions can be used. It can be shown that in the case of using the sum of individual utilities as the aggregation function, the aggregate of convex utilities is a convex function itself. This helps make the recursive application of the aggregation and optimization steps easier.

Summarization of utility functions in general involves loss of information and inaccuracy in the representation. In turn, this results in suboptimal allocation of energy. For example, in the case where utility functions are step functions, as shown in FIG. 2(B), an aggregate, but not summarized, utility function would have a number of steps equal to the sum of the steps among all individual functions. Various ways of summarizing individual functions exist, resulting in fewer steps for the aggregate function. Fewer steps imply less bandwidth for transmitting the aggregate function between different domains and less processing required for processing it. Embodiments of the invention provide a tunable parameter for adjusting the desired accuracy based on the available communication and processing bandwidth in the control network and the desired accuracy of energy distribution.

We now present an explanation of how the invention can be implemented on the different types of control elements described here.

FIG. 6 shows a block diagram for an intelligent energy consuming device 600 implementing techniques of the invention. The device provides an external interface to a user (consumer) or user agent 601 that allows programmability through a (graphical) user interface 602. The user can specify through this interface a marginal demand (utility function). In some cases, the user's input will be directly the marginal function, in some other cases it will be an indirect representation that is translated into a marginal function by the device. For example:

(i) The user may specify how much the user is willing to pay for different amounts of energy usage by the device. For example, for an electrical heater, the user may specify 2 KW (kilowatts) when the price is at or below P₁ and 1.2 KW when the price is higher than P₁.

(ii) Alternatively, the user may specify the energy usage in qualitative terms. Using the same device as above, the user may specify “High” when price is at or below P₁ and “Low” when the price is higher than P₁. The device is then capable of translating the “high” and “low” characterizations to internally achievable levels of energy consumption.

Device 600 is also equipped with one or more sensors 604 that are able to measure local parameters that are used to monitor current energy usage and external parameters that might be relevant in locally computing the utility function (for example, external temperature, humidity, etc.). The device further contains an actuator 606 that is responsible for appropriately managing internal circuitry that regulates the energy (or other commodity) consumption (generally denoted as electrical energy 605). This may include voltage regulators, current regulators, etc. The device contains a network interface 608 that provides data communications capabilities for connecting to the intelligent control network (shown in FIG. 1). For example, current utility can be reported (609) to the control network via the interface, and target consumption can be specified (611) to the device from the control network via the interface.

The network interface 608 may be implemented using IP over power lines, wireless IP link over the 802.11 protocol, IP over cable modem, or any other data networking technology that can connect to the rest of the control network. Device 600 may employ security software that allows it to connect with the control network securely, such as SSL (Secure Sockets Layer), IPSec (Internet Protocol Security), SSH (Secure Socket Shell), etc. Device 600 may also use special purpose security hardware, such as Trusted Platform Module (TPM) that assists in cryptographic operations and authenticates the identity of the validity of the device and its software to third parties with which it connects.

Device 600 also includes a processing element (processor 610) which controls the functions of the device such as establishment of connectivity with the network, collection of measurement (read device setting and use 612), compute utility functions and drive the actuators (actuate consumption level 614).

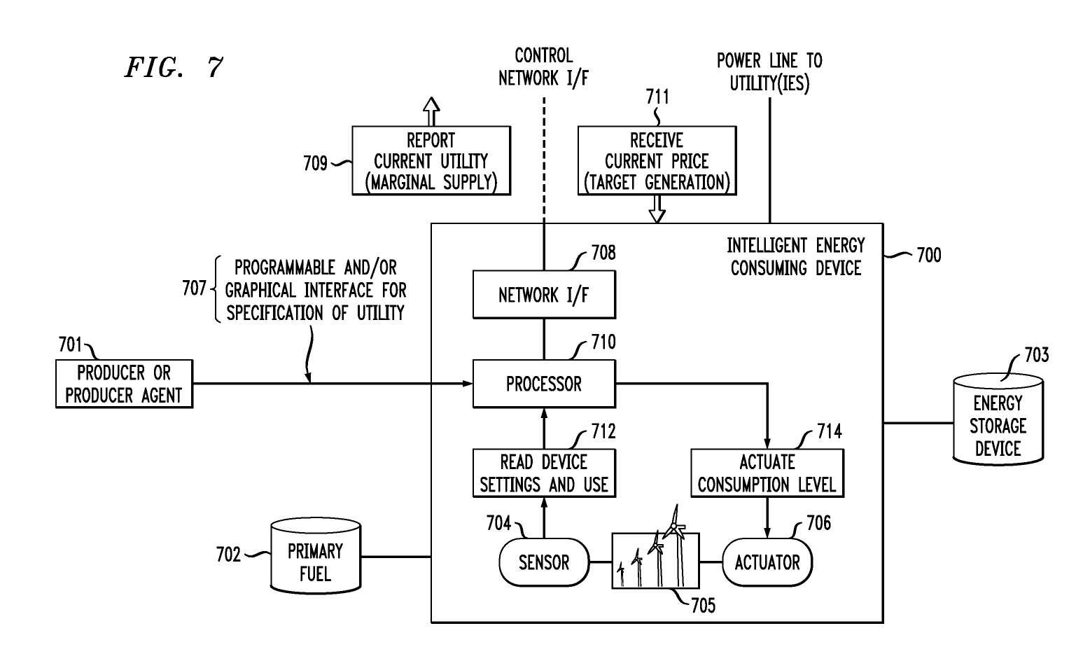

FIG. 7 shows a block diagram of an intelligent energy generating device 700 that implements techniques of the invention. This device has similar components compared to energy consuming device 660 of FIG. 6.

For instance, device 700 provides an external interface to a producer or producer agent 701 that allows programmability through a (graphical) user interface 707. The user can specify through this interface a marginal supply (utility function). Device 700 is also equipped with one or more sensors 704 that are able to measure local parameters that are used to monitor current energy supply and external parameters that might be relevant in locally computing the utility function (for example, external temperature, humidity, etc.). The device further contains an actuator 706 that is responsible for appropriately managing internal circuitry that regulates the energy (or other commodity) production (generally denoted as energy 705). This may include voltage regulators, current regulators, etc. The device contains a network interface 708 that provides data communications capabilities for connecting to the intelligent control network (shown in FIG. 1). For example, current utility can be reported (709) to the control network via the interface, and target production can be specified (711) to the device from the control network via the interface. The network interface may be implemented in a manner similar to that described above for the network interface of device 600.

Device 700 also includes a processing element (processor 710) which controls the functions of the device such as establishment of connectivity with the network, collection of measurement (read device setting and use 712), compute utility functions and drive the actuators (actuate production level 714).

As can been seen, device 700 actuates the level of production instead of the level of consumption. The device may optionally be connected to a local energy storage facility 703, such as a set of deep cycle batteries, local production of hydrogen using electrolysis, mechanical energy storage, etc. The device may also be connected to a primary fuel tank 702 which is consumed to generated energy (electricity), such as oil or natural gas. Alternatively the device may be controlling an alternative energy generation device such as solar panels, windmills, geothermal, hydroelectric, etc. The utility function in the case of an energy producing device is a marginal supply function, i.e., for different price levels, it indicates the amount of energy that the device is willing to generate. This function may depend on the amount of fuel in the storage tank, the amount of available storage capacity and other parameters.

Embodiments of the invention also propose a device that is a combination of an energy consumption device (device 600 of FIG. 6) and energy generation device (FIG. 7). In such a case, the utility function presented to the control network by the combined device may be the aggregation of the marginal demand and marginal supply functions of the respective device(s). Alternatively, the combined device may send only a marginal demand function or a marginal supply function. A combined device may therefore act as a net consumer for some (low) price levels and as a net producer for some different (higher) price levels. At any level of the control hierarchy shown in FIG. 1, the inventive techniques described herein serve to aggregate the utility functions in order to present a single one into the higher levels of the hierarchy.

It is to be understood that the consuming/producing devices and DER controllers referred to above may be implemented in accordance with one or more computing systems. Each such computing system may include a processor, memory, input/output (I/O) devices, and a network interface, coupled via a computer bus or alternate connection arrangement. The term “processor” as used herein is intended to include any processing device, such as, for example, one that includes a CPU and/or other processing circuitry. It is also to be understood that the term “processor” may refer to more than one processing device and that various elements associated with a processing device may be shared by other processing devices. The term “memory” as used herein is intended to include memory associated with a processor or CPU, such as, for example, RAM, ROM, a fixed memory device (e.g., hard drive), a removable memory device (e.g., diskette), flash memory, etc. In addition, the phrase “input/output devices” or “I/O devices” as used herein is intended to include, for example, one or more input devices (e.g., keyboard, mouse, etc.) for entering data to the processing unit, and/or one or more output devices (e.g., display, etc.) for presenting results associated with the processing unit. Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (i.e., more generally referred to as a computer or machine readable storage medium) and, when ready to be utilized, loaded in part or in whole (e.g., into RAM) and executed by a CPU. In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Advantageously, as explained above, embodiments of the invention provide a system and method for efficient summarization of electricity demand measurements in intelligent electrical grids using aggregation of marginal demand functions. Such system and method may also provide for efficient energy distribution in electrical grids using sensor and actuator networks based on consuming devices' marginal demand functions. Such system and method may also provide for distributed control of energy producing and consuming devices in an intelligent electrical grid given marginal supply and demand functions of the devices. Further, the system and method may provide for distributed hierarchical control of energy producing and consuming devices in an intelligent electrical grid given the devices' marginal supply and demand functions and using recursive optimization of allocation of electricity supply. Still further, the system and method may provide for distributed hierarchical control of production and distribution of an immutable commodity in a distribution network comprising intelligent producing and consuming devices and given the devices' marginal supply and demand functions.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. In a distributed commodity resource-based network wherein a first node in the network distributes an amount of the commodity to two or more other nodes in the network, a method of managing distribution of the commodity, the method comprising the steps of:
the first node obtaining two or more marginal demand functions, respectively, from the two or more other nodes, wherein a marginal demand function represents a price for a given amount of the commodity that a given node is willing to pay;
the first node aggregating the two or more marginal demand functions respectively obtained from the two or more other nodes to form an aggregated marginal demand function; and
the first node determining an optimal allocation of aggregate amounts of the commodity to the two or more other nodes based on the aggregated marginal demand function.

2. The method of claim 1, wherein the step of aggregating the two or more marginal demand functions to form the aggregated marginal demand function further comprises summing the two or more marginal demand functions.

3. The method of claim 2, wherein the step of determining the optimal allocation further comprises the allocation of the commodity to the two or more other nodes that maximizes the sum of the two or more marginal demand functions.

4. The method of claim 1, wherein the step of aggregating the two or more marginal demand functions to form the aggregated marginal demand function further comprises summing the two or more marginal demand functions and weighting the sum of the two or more marginal demand functions.

5. The method of claim 4, wherein the step of determining the optimal allocation further comprises the allocation of the commodity to the two or more other nodes that maximizes the weighted sum of the two or more marginal demand functions.

6. The method of claim 1, wherein the step of determining the optimal allocation further comprises using a max (min) operation.

7. The method of claim 1, wherein the commodity comprises an energy-based commodity.

8. The method of claim 7, wherein the energy-based commodity comprises electrical energy.

9. The method of claim 1, wherein the distributed commodity resource-based network comprises a distributed electrical grid network.

10. In a distributed commodity resource-based network wherein a first node in the network receives an amount of the commodity from two or more other nodes in the network, a method of managing production of the commodity, the method comprising the steps of:
the first node obtaining two or more marginal supply functions, respectively, from the two or more other nodes, wherein a marginal supply function represents a given amount of the commodity that a given node is willing to supply;
the first node aggregating the two or more marginal supply functions respectively obtained from the two or more other nodes to form an aggregated marginal supply function; and
the first node determining an optimal production of aggregate amounts of the commodity from the two or more other nodes based on the aggregated marginal supply function.

11. A device that at least one of consumes and produces a commodity in a distributed commodity resource-based network, the device comprising:
a processor;
a sensor coupled to the processor for monitoring at least one of consumption and production of the commodity;
an actuator coupled to the processor for controlling at least one of consumption and production of the commodity; and
an interface coupled to the processor for allowing the processor to communicate with the network;
wherein the processor generates one or more marginal utility functions that represent at least one of: (i) a price for a given amount of the commodity that the device is willing to pay when operating as a consumer of the commodity; and (ii) a given amount of the commodity that the device is willing to supply when operating as a producer of the commodity;
further wherein the processor sends the one or more marginal utility functions to a controller in the network for aggregating multiple marginal utility functions respectively obtained from multiple devices in the network and for determining at least one of an optimal allocation and production of the commodity.

12. Apparatus for managing distribution of a commodity in a distributed commodity resource-based network; the apparatus comprising:
a controller configured to perform the steps of:
obtaining two or more marginal demand functions, respectively, from two or more nodes in the network, wherein a marginal demand function represents a price for a given amount of the commodity that a given node is willing to pay;
aggregating the two or more marginal demand functions respectively obtained from the two or more nodes to form an aggregated marginal demand function; and
determining an optimal allocation of aggregate amounts of the commodity to the two or more nodes based on the aggregated marginal demand function.

13. The apparatus of claim 12, wherein the step of aggregating the two or more marginal demand functions to form the aggregated marginal demand function further comprises summing the two or more marginal demand functions.

14. The apparatus of claim 13, wherein the step of determining the optimal allocation further comprises the allocation of the commodity to the two or more nodes that maximizes the sum of the two or more marginal demand functions.

15. The apparatus of claim 12, wherein the step of aggregating the two or more marginal demand functions to form the aggregated marginal demand function further comprises summing the two or more marginal demand functions and weighting the sum of the two or more marginal demand functions.

16. The apparatus of claim 15, wherein the step of determining the optimal allocation further comprises the allocation of the commodity to the two or more nodes that maximizes the weighted sum of the two or more marginal demand functions.

17. The apparatus of claim 12, wherein the step of determining the optimal allocation further comprises using a max (min) operation.

18. The apparatus of claim 12, wherein the commodity comprises electrical energy.

19. The apparatus of claim 12, wherein the distributed commodity resource-based network comprises a distributed electrical grid network.

20. Apparatus for managing production of a commodity in a distributed commodity resource-based network; the apparatus comprising:
a controller configured to perform the steps of:
obtaining two or more marginal supply functions, respectively, from the two or more nodes in the network, wherein a marginal supply function represents a given amount of the commodity that a given node is willing to supply;
aggregating the two or more marginal supply functions respectively obtained from the two or more nodes to form an aggregated marginal supply function; and
determining an optimal production of aggregate amounts of the commodity from the two or more nodes based on the aggregated marginal supply function.
